(19) United States
(12) Patent Application Publication
(10) Pub. No.: US 2024/0275502 A1
(43) Pub. Date: Aug. 15, 2024

(54) APPARATUS, SYSTEM, AND METHOD FOR CALIBRATING MULTI-PORT RADIO DEVICES

(71) Applicant: University of Notre Dame du Lac, South Bend, IN (US)

(72) Inventors: Thomas G. Pratt, South Bend, IN (US); Robert D, Kossler, South Bend, IN (US); Jonathan Chisum, South Bend, IN (US); Luis Enrique Perez, South Bend, IN (US)

(21) Appl. No.: 18/438,130

(22) Filed: Feb. 9, 2024

Related U.S. Application Data
(60) Provisional application No. 63/484,278, filed on Feb. 10, 2023.

(51) Int. Cl. H04B 17/12; H04B 17/21

(52) U.S. Cl. CPC H04B 17/12; H04B 17/221

(57) ABSTRACT

A system for calibrating multi-port radio devices may include a radio device and circuitry. In one example, the radio device may include a reference port and a plurality of ports characterized by one or more radio-frequency (RF) imbalances relative to one another. Additionally or alternatively, the circuitry may be configured to calibrate the radio device by compensating for the one or more RF imbalances based at least in part on the reference port. Various other apparatuses, systems, and methods are also disclosed.

### PRIORITY CLAIM

This application claims the benefit of U.S. Provisional Application No. 63/484,278 filed Feb. 10, 2023, the disclosure of which is incorporated in its entirety by this reference.

### BACKGROUND

Multi-port radio devices are often susceptible to imbalances that lead to calibration errors. For example, a radio device that includes multiple transmitter ports and/or multiple receiver ports may be impaired by delay differences across the transmitter ports or receiver ports, component imperfections, temperature dependencies, relative clock drift, and/or other phenomena. Such impairments may lead to frequency-dependent gain and/or phase imbalances across the ports. These frequency-dependent gain and/or phase imbalances may cause polarization mischaracterizations and/or calibration errors that undermine the radio device's performance. The instant disclosure, therefore, identifies and addresses a need for apparatuses, systems, and methods that facilitate and/or support multi-port radio devices.

### SUMMARY

As will be described in greater detail below, the instant disclosure generally relates to apparatuses, systems, and methods for calibrating multi-port radio devices. In one example, a system for calibrating multi-port radio devices may include a radio device and circuitry. In this example, the radio device may include a reference port and a plurality of ports characterized by one or more radio-frequency (RF) imbalances relative to one another. Additionally or alternatively, the circuitry may be configured to calibrate the radio device by compensating for the one or more RF imbalances based at least in part on the reference port.

Similarly, a corresponding apparatus may include a radio device and circuitry. In one example, the radio device may include a poly-polarization antenna, a reference port, and a horizontally polarized port and a vertically polarized port communicatively coupled to the poly-polarization antenna. In one example, the horizontally polarized port and the vertically polarized port may be characterized by one or more RF imbalances relative to one another. Additionally or alternatively, the circuitry may be configured to calibrate the radio device by compensating for the one or more RF imbalances based at least in part on the reference port.

A corresponding method may include (1) communicatively coupling a plurality of ports included in a radio device to a poly-polarization antenna, the plurality of ports being characterized by one or more RF imbalances relative to one another, (2) communicatively coupling circuitry to the radio device, and/or (3) configuring the circuitry to calibrate the radio device by compensating for the one or more RF imbalances based at least in part on a reference port included in the radio device.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF DRAWINGS

The accompanying drawings illustrate a number of example embodiments and are a part of the specification. Together with the following description, these drawings demonstrate and explain various principles of the instant disclosure.

FIG. 1 is an illustration of an exemplary system for calibrating multi-port radio devices according to one or more implementations of this disclosure.

FIG. 2 is an illustration of an exemplary radio device capable of being calibrated based at least in part on a reference port according to one or more embodiments of this disclosure.

FIG. 3 is an illustration of an exemplary reference integrator included in a multi-port radio device according to one or more embodiments of this disclosure.

FIG. 4 is an illustration of an exemplary radio device capable of being calibrated based at least in part on a reference port according to one or more embodiments of this disclosure.

FIG. 5 is a flow diagram of an exemplary method for calibrating multi-port radio devices according to one or more implementations of this disclosure.

While the exemplary embodiments described herein are susceptible to various modifications and alternative forms, specific embodiments have been shown by way of example in the appendices and will be described in detail herein. However, the exemplary embodiments described herein are not intended to be limited to the particular forms disclosed. Rather, the instant disclosure covers all modifications, combinations, equivalents, and alternatives falling within this disclosure.

### DETAILED DESCRIPTION OF EXEMPLARY EMBODIMENTS

The present disclosure is generally directed to apparatuses, systems, and methods for calibrating multi-port radio devices. As will be explained in greater detail below, these apparatuses, systems, and methods may provide numerous features, benefits, and/or advantages.

In some examples, a system includes and/or represents a radio device and circuitry. In one example, the radio device is equipped with a plurality of ports characterized by one or more RF imbalances relative to one another. For example, the radio device includes and/or represents a horizontally polarized transmitter and/or receiver port and a vertically polarized transmitter and/or receiver port that have and/or exhibit one or more phase and/or gain imbalances. In one example, such phase and/or gain imbalances may be a function of frequency. Additionally or alternatively, the radio device is further equipped with a reference port that facilitates and/or supports calibrating the plurality of ports characterized by the RF imbalance(s). For example, the radio device includes and/or represents a positive or negative slant 45-degree polarized port, a left-hand circular polarized port, or a right-hand circular polarized port that enables the circuitry to calibrate the vertically and horizontally polarized ports by compensating and/or accounting for the phase and/or gain imbalances.

In some examples, the circuitry is configured to calibrate the plurality of ports by generating a matrix representing a characterization of the radio device. For example, the circuitry generates and/or populates a matrix that implements Jones and/or Mueller calculus with one or more estimates and/or representations of polarization states of the horizontally and vertically polarized ports. In one example, the circuitry determines, calculates, and/or identifies one or more calibration factors based at least in part on the matrix. In this example, the circuitry estimates, calculates, and/or derives a target full-polarization response representing an objective calibration for the radio device based at least in part on the calibration factors. The circuitry then calibrates the radio device based at least in part on the target-response matrix.

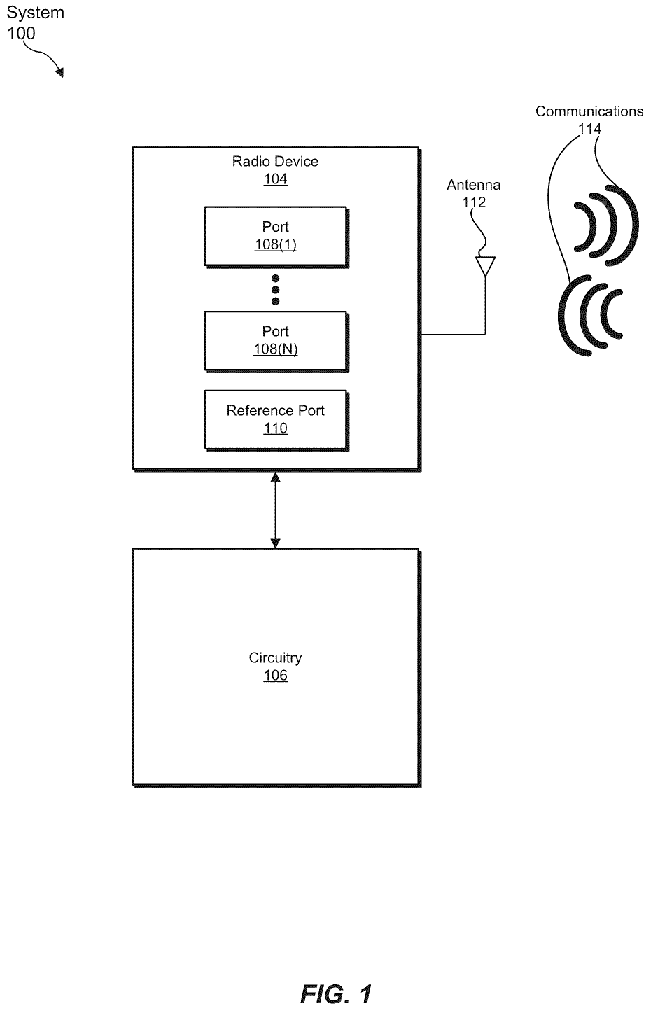

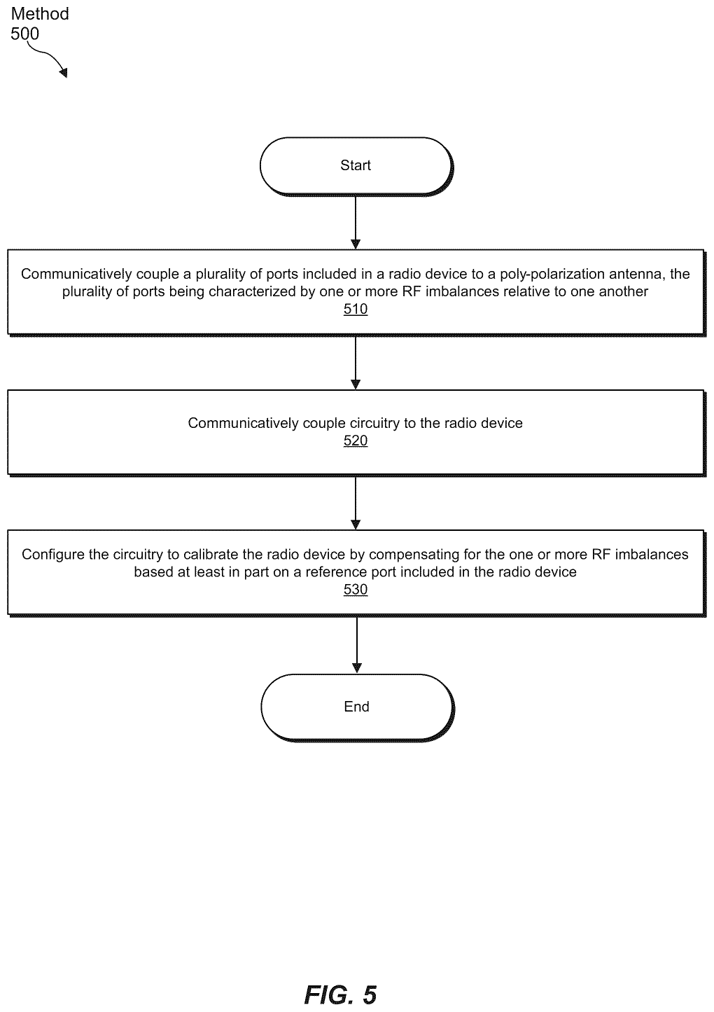

The following will provide, with reference to FIGS. 1-4, detailed descriptions of exemplary apparatuses, devices, systems, components, and corresponding configurations or implementations for calibrating multi-port radio devices. In addition, detailed descriptions of methods for calibrating multi-port radio devices will be provided in connection with FIG. 5.

FIG. 1 illustrates an exemplary system 100 for calibrating multi-port radio devices. As illustrated in FIG. 1, system 100 includes and/or represents a radio device 104 and circuitry 106. In some examples, radio device 104 is configured to transmit and/or receive communications 114 (e.g., RF signals) via an antenna 112. In one example, radio device 104 includes and/or represents ports 108(1)-(N) and a reference port 110. In this example, ports 108(1)-(N) include and/or represent transmitter ports and/or receiver ports. In certain implementations, antenna 112 is configured to support communications 114 in connection with ports 108(1)-(N) and/or reference port 110.

In some examples, ports 108(1)-(N) are characterized by one or more RF imbalances (e.g., phase and/or gain differences) relative to one another. In one example, radio device 104 include and/or represents a transceiver, a transmitter, and/or a receiver. In this example, ports 108(1)-(N) include and/or represent transmitter ports having and/or being characterized by the RF imbalance(s). For example, the transmitter may have and/or be characterized by a differential between the phases and/or gains of the transmitter ports as a function of frequency. Additionally or alternatively, ports 108(1)-(N) include and/or represent receiver ports having and/or being characterized by the RF imbalance(s). For example, the receiver may have and/or be characterized by a differential between the phases and/or gains of the receiver ports as a function of frequency.

In some examples, circuitry 106 is communicatively coupled to and/or integrated into radio device 104. In one example, circuitry 106 is configured to calibrate radio device 104 by compensating for the RF imbalance(s) based at least in part on reference port 110. In this example, circuitry 106 generates and/or populates one or more matrices representing a characterization of radio device 104 based at least in part on reference port 110. Additionally or alternatively, circuitry 106 determines, estimates, calculates, and/or derives one or more calibration factors based at least in part on one or more of the matrices. In one example, circuitry 106 determines, estimates, calculates, and/or derives a target response (e.g., a full-polarization response) representing an objective calibration for radio device 104 based at least in part on calibration factors. In certain implementations, circuitry 106 calibrates radio device 104 by modifying ports 108(1)-(N) to account for the calibration factor(s), thereby mitigating and/or eliminating the RF imbalance(s) of ports 108(1)-(N).

In some examples, the matrix may include and/or represent one or more estimates of polarization states of the ports 108(1)-(N), one or more estimates of the RF imbalances, and/or a target calibration response. One or more of the matrices may implement and/or be based on Jones calculus and/or Mueller calculus. Additionally and/or alternatively, the calibration factor(s) may include, constitute, and/or involve a target-response matrix representing an objective and/or goal calibration of radio device 104. In one example, circuitry 106 may calibrate radio device 104 based at least in part on the target-response matrix.

In some examples, radio device 104 includes and/or implements any type or form of suitable RF and/or communications technology. For example, radio device 104 may include and/or represent certain radar technologies, components, and/or systems. Additionally or alternatively, radio device 104 may include and/or implement linear frequency modulated (LFM) waveform technology. Additional examples of radio device 104 include, without limitation, multiple-input and multiple-output (MIMO) radio devices, millimeter-wave (mmWave) radio devices, frequency-modulated continuous-wave (FMCW) radio devices, sinusoidal-wave radio devices, sawtooth-wave radio devices, triangle-wave radio devices, square-wave radio devices, pulse radio devices, chirp radio devices, variations or combinations of one or more of the same, and/or any other suitable radio devices.

In some examples, circuitry 106 includes and/or represents one or more electrical and/or electronic circuits capable of processing, applying, modifying, transforming, displaying, transmitting, receiving, and/or executing data for system 100. In one example, circuitry 106 may process the RF signal reflections received by radio device 104 and/or detect one or more objects based at least in part on the signal reflections. In this example, circuitry 106 may generate and/or modify data representative of ranging measurements and/or readings based at least in part on the signal reflections. Additionally or alternatively, circuitry 106 may provide such ranging data for visual presentation and/or further processing in connection with system 100.

In some examples, radio device 108 may enable system 100 to communicate with another device and/or system by transmitting RF signals to the other device and/or system and/or receiving RF signals from the other device and/or system. In one example, circuitry 106 may deliver and/or provide data to be converted into RF signals transmitted by radio device 104. Additionally or alternatively, circuitry 106 may process RF signals received by radio device 104 and/or interpret and/or convert RF signals into data. In this example, circuitry 106 may use such data to trigger and/or initiate one or more actions in system 100.

In some examples, circuitry 106 may launch, perform, and/or execute certain executable files, code snippets, and/or computer-readable instructions to facilitate and/or support calibrating multi-port radio devices. Although illustrated as a single unit in FIG. 1, circuitry 106 may include and/or represent a collection of multiple processing units and/or electrical or electronic components that work and/or operate in conjunction with one another. In one example, circuitry 106 may include and/or represent one or more application-specific integrated circuit (ASICs). In another example, circuitry 106 may include and/or represent one or more central processing unit (CPUs). Additional examples of circuitry 106 include, without limitation, processing devices, microprocessors, microcontrollers, graphics processing units (GPUs), field-programmable gate arrays (FPGAs), systems on chips (SoCs), parallel accelerated processors, tensor cores, integrated circuits, chiplets, optical modules, receivers, transmitters, transceivers, optical modules, antennas, portions of one or more of the same, variations or combinations of one or more of the same, and/or any other suitable circuitry. In certain implementations, some or all of circuitry 106 may be incorporated and/or integrated into radio device 104.

In some examples, ports 108(1)-(N) and reference port 110 may deliver, provide, resonate, modulate, and/or transmit RF signals of different polarizations to and/or for antenna 112. Additionally or alternatively, ports 108(1)-(N) and reference port 110 may obtain and/or receive RF signals of different polarizations from antenna 112. For example, port 108(1) may facilitate and/or support communications via RF signals of one polarization, and port 108(N) may facilitate and/or support communications via RF signals of a different polarization. In this example, reference port 110 may facilitate and/or support communications via RF signals of another polarization. In certain implementations, the polarizations of ports 108(1)-(N) and reference port 110 may all differ from one another.

In some examples, ports 108(1) and 108(N) may facilitate, support, and/or implement orthogonally oriented polarizations (e.g., horizontal and vertical polarizations). In one example, reference port 110 may facilitate, support, and/or implement another polarization that is offset between the orthogonal polarizations of ports 108(1) and 108(N).

As specific example, port 108(1) may facilitate, support, and/or implement horizontally polarized signals and/or communications. In this example, port 108(N) may facilitate, support, and/or implement vertically polarized signals and/or communications. Reference port 110 may facilitate, support, and/or implement positive (+) or negative (−) slant 45-degree polarized signals and/or communications. Additionally or alternatively, reference port 110 may facilitate, support, and/or implement righthand or lefthand circularly polarized signals and/or communications.

In some examples, antenna 112 may include and/or represent a poly-polarization antenna that supports RF communications of different polarizations. In one example, antenna 112 may constitute and/or implement a dual-polarization architecture that supports two different polarizations, such as orthogonally oriented polarizations (e.g., horizontal and vertical polarizations). In another example, antenna 112 may constitute and/or implement a tri-polarization architecture that supports three different polarizations (e.g., horizontal, vertical, and slanted 45-degree polarizations).

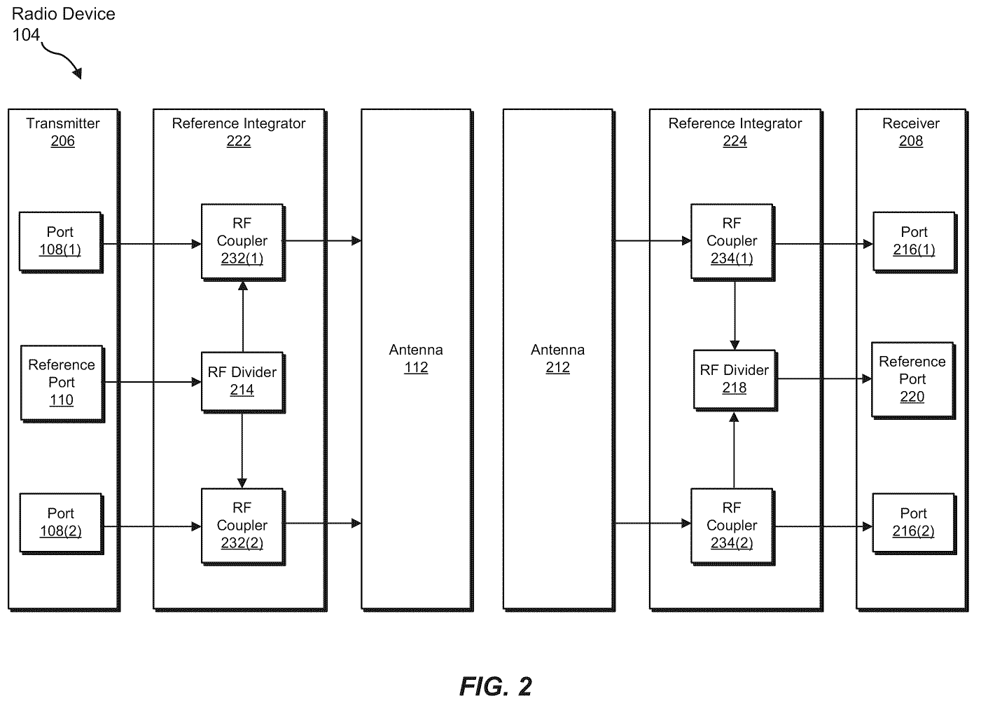

FIG. 2 illustrates an exemplary implementation of radio device 104 capable of being calibrated based at least in part on reference ports 110 and 220. In some examples, radio device 104 may include and/or represent certain devices, components, and/or features that perform and/or provide functionalities that are similar and/or identical to those described above in connection with FIG. 1. As illustrated in FIG. 2, radio device 104 may include and/or represent a transceiver capable to transmitting and/or receiving RF signals. In one example, radio device 104 may include and/or represent a transmitter 206 and/or a receiver 208. In this example, radio device 104 may also include and/or represent a reference integrator 222 and/or a reference integrator 224. Additionally or alternatively, radio device 104 may include and/or represent an antenna 112 and/or an antenna 212.

In some examples, reference integrator 222 may be communicatively coupled between transmitter 206 and antenna 112. Additionally or alternatively, reference integrator 224 may be communicatively coupled between receiver 208 and antenna 212. In one example, transmitter 206 may include and/or represent ports 108(1) and 108(2) as well as reference port 110. In this example, receiver 208 may include and/or represent ports 216(1) and 216(2) as well as reference port 220.

In some examples, reference integrator 222 may include and/or represent RF couplers 232(1) and 232(2) as well as an RF divider 214. In one example, ports 108(1) and 108(2) of transmitter 206 may be communicatively coupled to RF couplers 232(1) and 232(2) of reference integrator 222. In this example, RF couplers 232(1) and 232(2) of reference integrator 222 may be communicatively coupled to RF divider 214. In certain implementations, RF divider 214 may be communicatively coupled to RF couplers 232(1) and 232(2).

In some examples, reference integrator 224 may include and/or represent RF couplers 234(1) and 234(2) as well as an RF divider 218. In one example, ports 216(1) and 216(2) of receiver 208 may be communicatively coupled to RF couplers 234(1) and 234(2) of reference integrator 224. In this example, reference port 220 may be communicatively coupled to RF divider 218. In certain implementations, RF divider 218 may be communicatively coupled to RF couplers 234(1) and 234(2).

In some examples, reference integrators 222 and 224 may each include and/or represent an antenna appliqué and/or circuit that communicatively couples RF signals from two antenna ports and/or channels via RF couplers. In one example, reference integrators 222 and 224 may include, involve, and/or represent a third port and/or channel from transmitter 206 and receiver 208, respectively.

In some examples, circuitry 106 may tap into and/or be communicatively coupled to one or more nodes of radio device 104. For example, circuitry 106 may be communicatively coupled to radio device 104 between transmitter 206 and reference integrator 222 and/or between receiver 208 and reference integrator 224. In another example, circuitry 106 may be communicatively coupled to radio device 104 between reference integrator 222 and antenna 112 and/or between reference integrator 224 and antenna 212. Additionally or alternatively, circuitry 106 may be communicatively coupled to radio device 104 at transmitter 206, receiver 208, antenna 112, and/or antenna 212. Circuitry 106 may take certain measurements of radio device 104 to determine RF imbalances that exist and/or are exhibited across ports 108(1) and 108(2) and/or across ports 216(1) and 216(2).

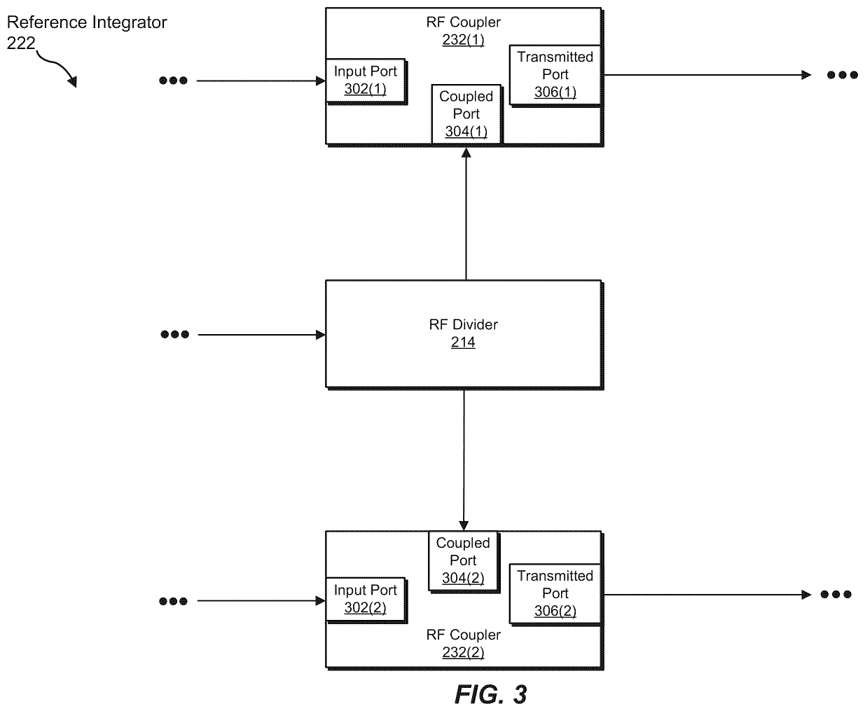

FIG. 3 illustrates an exemplary implementation of reference integrator 222 included in radio device 104. In some examples, reference integrator 222 may include and/or represent certain devices, components, and/or features that perform and/or provide functionalities that are similar and/or identical to those described above in connection with FIG. 1 and/or FIG. 2. As illustrated in FIG. 3, reference integrator 222 may include and/or represent RF couplers 232(1) and 232(2) as well as RF divider 214. In one example, RF coupler 232(1) may include and/or represent an input port 302(1), a coupled port 304(1), and/or a transmitted port 306(1). Additionally or alternatively, RF coupler 232(2) may include and/or represent an input port 302(2), a coupled port 304(2), and/or a transmitted port 306(2).

In some examples, input port 302(1) of RF coupler 232(1) may be communicatively coupled to port 108(1) of transmitter 206, and/or transmitted port 306(1) of RF coupler 232(1) may be communicatively coupled to one polarization port of antenna 112. In one example, input port 302(2) of RF coupler 232(2) may be communicatively coupled to port 108(2) of transmitter 206, and/or transmitted port 306(2) of RF coupler 232(2) may be communicatively coupled to another polarization port of antenna 112. Additionally or alternatively, coupled port 304(1) of RF coupler 232(1) may be communicatively coupled to RF divider 214, and/or coupled port 304(2) of RF coupler 232(2) may be communicatively coupled to RF divider 214.

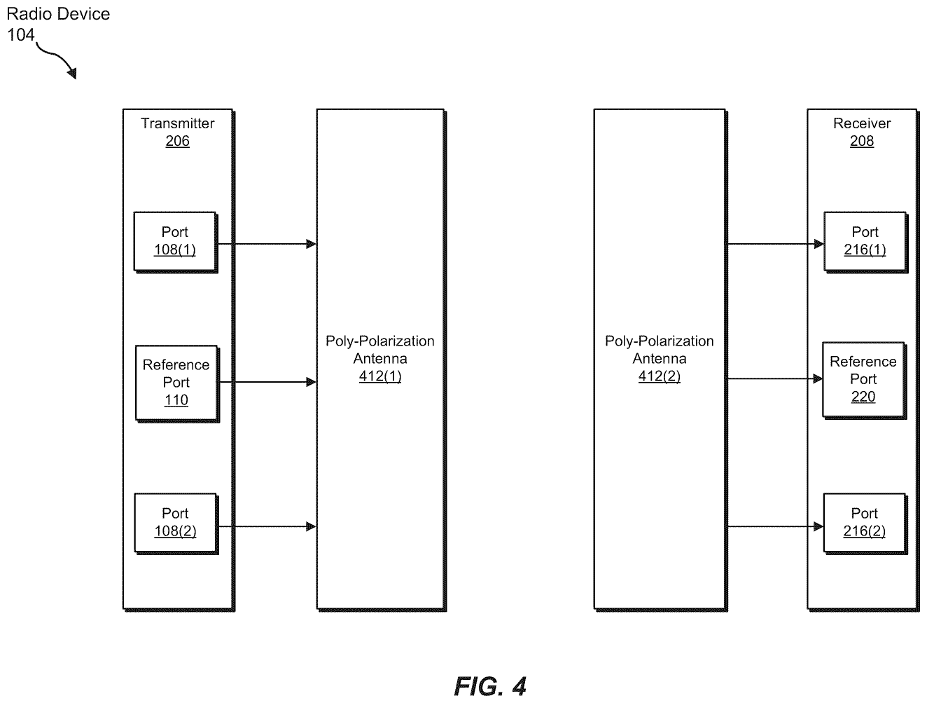

FIG. 4 illustrates an exemplary implementation of radio device 104 capable of being calibrated based at least in part on reference ports 110 and 220. In some examples, radio device 104 may include and/or represent certain devices, components, and/or features that perform and/or provide functionalities that are similar and/or identical to those described above in connection with any of FIGS. 1-3. As illustrated in FIG. 4, radio device 104 may include and/or represent transmitter 206, receiver 208, and/or poly-polarization antennas 412(1) and 412(2).

In some examples, transmitter 206 may include and/or represent ports 108(1) and 108(2) communicatively coupled to different polarization ports of poly-polarization antenna 412(1). Additionally or alternatively, transmitter 206 may include and/or represent reference port 110 communicatively coupled to another polarization port of poly-polarization antenna 412(1). In one example, poly-polarization antenna 412(1) may be tri-polarized to support RF communications of three different polarizations (e.g., horizontal, vertical, and slanted 45-degree polarizations) in connection with ports 108(1) and 108(2) and reference port 110.

In some examples, reference port 110 may create a slant-45 signal that is combined via reference integrator 222. In one example, circuitry 106 may use the resulting reference signal to calibrate the gain and/or phase differences between the horizontally polarized and vertically polarized ports. When the horizontally polarized and vertically polarized ports are properly calibrated at transmitter 206 and receiver 208, circuitry 106 may be able to accurately generate arbitrary polarizations at transmitter 206 by controlling the relative gain and phase of a signal transmitted coherently through the horizontally polarized and vertically polarized ports. Similarly, with proper calibration of the receiver ports, circuitry 106 may be able to accurately characterize the polarization of the signal received at receiver 208. With this approach, radio device 104 may obviate the need for cable connections used in conventional calibration approaches. Accordingly, this approach enables circuitry 106 to determine the gain and/or phase imbalances based on over-the-air signals that are transmitted and/or received via radio device 104.

In some examples, receiver 208 may include and/or represent ports 216(1) and 216(2) communicatively coupled to different polarization ports of poly-polarization antenna 412(2). Additionally or alternatively, receiver 208 may include and/or represent reference port 210 communicatively coupled to another polarization port of poly-polarization antenna 412(1). In one example, poly-polarization antenna 412(1) may be tri-polarized to support RF communications of three different polarizations (e.g., horizontal, vertical, and slanted 45-degree polarizations) in connection with ports 216(1) and 216(2) and reference port 220.

In some examples, circuitry 106 may tap into and/or be communicatively coupled to one or more nodes of radio device 104. For example, circuitry 106 may be communicatively coupled to radio device 104 between transmitter 206 and poly-polarization antenna 412(1) and/or between receiver 208 and poly-polarization antenna 412(2). Additionally or alternatively, circuitry 106 may be communicatively coupled to radio device 104 at transmitter 206, receiver 208, poly-polarization antenna 412(1), and/or poly-polarization antenna 412(2). Circuitry 106 may take certain measurements of radio device 104 to determine RF imbalances that exist and/or are exhibited across ports 108(1) and 108(2) and/or across ports 216(1) and 216(2).

In some examples, circuitry 106 may analyze, measure, and/or characterize transfer gains for all transmitter and/or receiver polarization antenna pairs (e.g., as a function of the frequency components of the corresponding RF signal). For example, circuitry 106 may analyze, measure, and/or characterize the phase and/or gain of ports 108(1) and 108(2) and/or ports 216(1) and 216(2). In one example, circuitry 106 may estimate, calculate, and/or model full-polarization representations of radio device 104 to generate and/or populate Jones-based and/or Mueller-based matrices that account for the phase and/or gain measurements. In this example, the Jones-calculus and/or Mueller-calculus matrices may correspond to and/or represent polarization states of ports 108(1) and 108(2) and/or ports 216(1) and 216(2). In certain implementations, circuitry 106 may estimate, model, and/or approximate RF imbalances and/or target responses of transmitter 206 and/or receiver 208 based at least in part on such Jones-calculus and/or Mueller-calculus matrices.

In some examples, circuitry 106 may calibrate radio device 104 by compensating and/or modifying ports 108(1) and 108(2) and/or ports 216(1) and 216(2) to mitigate, reduce, and/or eliminate the RF imbalances. For example, circuitry 106 may achieve phase-coherence, phase-alignment, and/or gain-matching across ports 108(1) and 108(2) and/or across ports 216(1) and 216(2). By doing so, circuitry 106 may be able to measure and/or control the signal polarization states for a full response and/or target response of system 100 and/or radio device 104.

In some examples, transmitter 206 may transmit a radio signal x(t) that propagates through a medium having vector channel impulse responses hᵥ(t)=[hᵥₕ(t)hᵥᵥ(t)]^{T} associated with the vertically polarized transmission and hₕ(t)=[hₕₕ(t)hₕᵥ(t)]^{T} associated with the horizontally polarized transmission. In one example, circuitry 106 may measure and/or observe the components of the channel impulse responses at the two ports of the receiver antenna. The received signal vectors associated with the two transmission polarizations may be represented as

$$[ \begin{matrix}{y}_{vh} ( t ) \\ {y}_{vv} ( t )\end{matrix} ] = x ( t ) * {h}_{v} ( t ) and [ \begin{matrix}{y}_{hh} ( t ) \\ {y}_{hv} ( t )\end{matrix} ] = x ( t ) *$$

hₕ(t), where the subscript of vector channel h corresponds to the transmission polarization and the subscript pairs of y correspond to the transmit and receive antenna polarizations.

In some examples, the transmit polarization may be represented as a linear combination of orthogonally polarized components through a unit Jones vector. For example, a Jones vector ρ=[ρₕ ρᵥ]^{T} may correspond to and/or represent the transmit polarization state. The transmit polarization based on Jones calculus may be represented as

$$[ \begin{matrix}{y}_{h} ( t ) \\ {y}_{v} ( t )\end{matrix} ] = {J}_{hv} ( t ) ρ * x ( t ) + [ \begin{matrix}{n}_{h} ( t ) \\ {n}_{v} ( t )\end{matrix} ]$$

in the time domain, where nₕ(t) and nᵥ(t) are zero-mean complex Gaussian distributions, Jₕᵥ is the Jones matrix for basis polarizations h and v, and each component in the Jₕᵥ matrix corresponds to the transfer gain from the x-polarized transmitter and the y-polarized receiver. Additionally or alternatively, the full-system response may be represented as Jₕᵥ(t)=QP(t)K. In this example, the Jₕᵥ(t) matrix may include and/or represent the transmitter port imbalances, the receiver port imbalances, and/or the target response.

In some examples, the transmit and receive channel imbalances may be represented as

$$K = [ \begin{matrix}{K}_{h} & 0 \\ 0 & {K}_{v}\end{matrix} ] and Q = [ \begin{matrix}{Q}_{h} & 0 \\ 0 & {Q}_{v}\end{matrix} ] ,$$

respectively. Additionally or alternatively, the full-polarization target response may be represented as

$$P ( t ) = [ \begin{matrix}{P}_{hh} ( t ) & {P}_{vh} ( t ) \\ {P}_{hv} ( t ) & {P}_{vv} ( t )\end{matrix} ] ,$$

where the matrix elements Pᵥᵥ(t), Pᵥₕ(t), Pₕᵥ(t), and Pₕₕ(t) are full polarization target response coefficients. In one example, the polarization state may be defined over a time interval and signal bandwidth. By utilizing and/or relying on sub-band representations that are sufficiently narrow, circuitry 106 may be able to ensure that radio device 104 achieves a high degree of polarization (e.g., absolute and/or full polarization).

In certain examples, the transmit polarization based on Jones calculus may be represented as

$$[ \begin{matrix}{Y}_{h} [ k ] \\ {Y}_{v} [ k ]\end{matrix} ] = {J}_{hv} [ k ] ρ X [ k ] + [ \begin{matrix}{N}_{h} [ k ] \\ {N}_{v} [ k ]\end{matrix} ] = Q [ k ] P [ k ] K [ k ] ρ X [ k ] + [ \begin{matrix}{N}_{h} [ k ] \\ {N}_{v} [ k ]\end{matrix} ]$$

in the frequency domain, where K[k] and Q[k] are compensation matrices used by circuitry 106 to calibrate and/or compensate the transmit and/or receive channels and/or ports. In one example, circuitry 106 may compute the Jones matrix for each subcarrier k and/or estimate the output polarization state for an arbitrary input polarization state and any subcarrier frequency. Circuitry 106 may do so by (1) weighting the E-field components to achieve the desired polarization state, (2) applying the Jones matrix associated with the subcarrier frequency of interest, and then (3) computing the polarization states and/or losses from the output E-field components.

In some examples, circuitry 106 may estimate, calculate, and/or model the complex gain for each subcarrier (e.g., sideband of the carrier frequency). In one example, circuitry 106 may estimate and/or determine channel transfer gains characterized as a function of frequency based at least in part on the estimated complex gains. In this example, the channel transfer gains may be used directly in the Jones transmission matrix associated with each subcarrier k, which is represented as

$${\hat{J}}_{hv} [ k ] = [ \begin{matrix}{H}_{hh} [ k ] & {H}_{vh} [ k ] \\ {H}_{hv} [ k ] & {H}_{vv} [ k ]\end{matrix} ] ,$$

where Hᵢₗ are complex channel estimates from transmit polarization i to receiver polarization l. In certain implementations, the matrix may be frequency dependent if the channel is frequency selective. Additionally or alternatively, the orthogonally polarized signals may be transmitted and received in a phase-coherent and phase-aligned way to achieve a phase-coherent Jones matrix.

In some examples, from the estimated coherent Jones matrix, circuitry 106 may implement a linear combination of transmit signal components (e.g., to represent an arbitrary polarization) used to find the corresponding output Jones vector for any subcarrier k. Such a linear combination of transmit signal components may be represented as

$$[ \begin{matrix}{Y}_{h} [ k ] \\ {Y}_{v} [ k ]\end{matrix} ] = [ \begin{matrix}{H}_{hh} [ k ] & {H}_{vh} [ k ] \\ {H}_{hv} [ k ] & {H}_{vv} [ k ]\end{matrix} ] [ \begin{matrix}{ρ}_{v}^{in} \\ {ρ}_{h}^{in}\end{matrix} ] X [ k ] .$$

In one example, the corresponding output Stokes vector may be derived and/or obtained from the linear combination Yₕ[k] and Yᵥ[k] for subcarrier k.

In some examples, the objective of the calibration may be to enable circuitry 106 to estimate, calculate, and/or model a full-polarization target response matrix represented as P[k]=Q⁻¹ [k]Jₕᵥ[k]K⁻¹ [k], where Q⁻¹[k] and K⁻¹ [k] are calibration factors. In one example, circuitry 106 may estimate, calculate, and/or model corresponding compensation matrix K[k] representing the gain and/or phase imbalances between the transmit ports and/or compensation matrix Q[k] representing the gain and/or phase imbalances between the receive ports. Additionally or alternatively, circuitry 106 may use the reference ports to estimate, calculate, and/or model the RF imbalances between the transmit ports and/or the receive ports.

In some examples, circuitry 106 may compensate the system response to isolate the full-polarization target response with a slant 45-degree reference port for the augmented system. In one example, such a full-polarization target response may be represented as

$$[ \begin{matrix}{y}_{h} ( t ) \\ {y}_{s 45} ( t ) \\ {y}_{v} ( t )\end{matrix} ] = [ \begin{matrix}{h}_{hh} ( t ) & {h}_{s 45 h} ( t ) & {h}_{vh} ( t ) \\ {h}_{hs 45} ( t ) & {h}_{s 45 s 45} ( t ) & {h}_{vs 45} ( t ) \\ {h}_{hv} ( t ) & {h}_{s 45 v} ( t ) & {h}_{vv} ( t )\end{matrix} ] [ \begin{matrix}{ρ}_{h} \\ {ρ}_{s 45} \\ {ρ}_{v}\end{matrix} ] * x ( t ) + [ \begin{matrix}{n}_{h} ( t ) \\ {n}_{s 45} ( t ) \\ {n}_{v} ( t )\end{matrix} ]$$

in the time domain. In this example, the full-polarization target response may be represented as

$$[ \begin{matrix}{Y}_{h} [ k ] \\ {Y}_{s 45} [ k ] \\ {Y}_{v} [ k ]\end{matrix} ] = [ \begin{matrix}{H}_{hh} [ k ] & {H}_{s 45 h} [ k ] & {H}_{vh} [ k ] \\ {H}_{hs 45} [ k ] & {H}_{s 45 s 45} [ k ] & {H}_{vs 45} [ k ] \\ {H}_{hv} [ k ] & {H}_{s 45 v} [ k ] & {H}_{vv} [ k ]\end{matrix} ] ρ X [ k ] + [ \begin{matrix}{N}_{h} [ k ] \\ {N}_{s 45} [ k ] \\ {N}_{v} [ k ]\end{matrix} ]$$

in the frequency domain. In certain implementations, compensation matrices K[k] and Q[k] may be represented as

$$H [ k ] = C [ k ] [ \begin{matrix}\frac{{H}_{vs 45} [ k ]}{{H}_{hs 45} [ k ]} & 0 \\ 0 & 1\end{matrix} ] and Q [ k ] = R [ k ] [ \begin{matrix}\frac{{H}_{s 45 v} [ k ]}{{H}_{s 45 h} [ k ]} & 0 \\ 0 & 1\end{matrix} ] ,$$

where C[k] and R[k] are arbitrary complex scaling factors that have no impact on the polarization estimate. In one implementation, the C[k] and R[k] complex scaling factors may be set to unity.

A specific numerical example of a system and target response for a single frequency component follows. In this example, gain and phase imbalances exist and are measurable via reference integrators and/or antenna appliques that implement orthogonally polarized transmitters and/or receivers with slant 45-degree reference ports. In one example, the transmit signal parameters for this system may correspond to and/or be represented as 1600 tones (block size), 12.5-kilohertz of tone separation, 20-megahertz signal bandwidth, vertical-horizontal-slanted interleaved polarizations, and/or identical tone signal amplitudes. In this example, circuitry 106 may characterize, assume, and/or represent the target response as

$$P = [ \begin{matrix}1 & j \\ 3 {e}^{j π / 5} & 5 {e}^{- j π / 16}\end{matrix} ] .$$

Additionally or alternatively, circuitry 106 may characterize, assume, and/or represent the gain and phase imbalances at the transmitter and the receiver as

$$Q = [ \begin{matrix}4 {e}^{- j 2 π / 3} & 0 \\ 0 & 1\end{matrix} ] and K = [ \begin{matrix}0.2 {e}^{j 2 π / 3} & 0 \\ 0 & 1\end{matrix} ] ,$$

respectively.

Continuing with this specific numerical example, circuitry 106 may characterize, assume, and/or represent the measured response for the unaugmented system (e.g., using the hv polarization basis) as

$${J}_{hv} = QPK = [ \begin{matrix}4 {e}^{- j 2 π / 3} & 0 \\ 0 & 1\end{matrix} ] [ \begin{matrix}1 & j \\ 3 {e}^{j π / 5} & 5 {e}^{- j π / 16}\end{matrix} ] [ \begin{matrix}0.2 {e}^{j 2 π / 3} & 0 \\ 0 & 1\end{matrix} ] = [ \begin{matrix}0.8 {e}^{- j 1.04} & 4 {e}^{- j 0.52} \\ 0.6 {e}^{j 1.67} & 5 {e}^{- j 0.19}\end{matrix} ] .$$

In this example, the inverse of this system response Jₕᵥ⁻¹ may enable circuitry 106 to estimate, derive, and/or extrapolate the polarization state of the signal transmitted by the transmitter. In one example, circuitry 106 and/or radar device 104 may measure the response for the augmented system, which is represented as

$$H = [ \begin{matrix}0.8 {e}^{- j 1.04} & 1 & 4 {e}^{- j 0.52} \\ 1 & 1 & 0.2 {e}^{j π / 3} \\ 0.6 {e}^{j 1.67} & 4 {e}^{- j 2 π / 3} & 5 {e}^{- j 0.19}\end{matrix} ] .$$

From this measured response matrix H, circuitry 106 may estimate, calculate, and/or model the corresponding calibration factors

$$\hat{Q} = [ \begin{matrix}4 {e}^{- j 2 π / 3} & 0 \\ 0 & 1\end{matrix} ] and \hat{K} = [ \begin{matrix}0.2 {e}^{j 2 π / 3} & 0 \\ 0 & 1\end{matrix} ] .$$

Circuitry 106 may then apply these calibration factors Q and K to the system Jones matrix to isolate the target response estimate as

$$\hat{P} = {\hat{Q}}^{- 1} {J}_{hv} {\hat{K}}^{- 1} = [ \begin{matrix}1 & j \\ 3 {e}^{j π / 5} & 5 {e}^{- j π / 16}\end{matrix} ] .$$

In some examples, the various apparatuses, devices, and systems described in connection with FIGS. 1-4 may include and/or represent one or more additional circuits, components, and/or features that are not necessarily illustrated and/or labeled in FIGS. 1-4. For example, the apparatuses, devices, and systems illustrated in FIGS. 1-4 may also include and/or represent additional analog and/or digital circuitry, onboard logic, transistors, radar devices, RF transmitters, RF receivers, transceivers, antennas, resistors, capacitors, diodes, inductors, switches, registers, flipflops, digital logic, connections, traces, buses, semiconductor (e.g., silicon) devices and/or structures, processing devices, storage devices, circuit boards, sensors, packages, substrates, housings, combinations or variations of one or more of the same, and/or any other suitable components. In certain implementations, one or more of these additional circuits, components, and/or features may be inserted and/or applied between any of the existing circuits, components, and/or features illustrated in FIGS. 1-4 consistent with the aims and/or objectives described herein. Accordingly, the couplings and/or connections described with reference to FIGS. 1-4 may be direct connections with no intermediate components, devices, and/or nodes or indirect connections with one or more intermediate components, devices, and/or nodes.

In some examples, the phrase “to couple” and/or the term “coupling,” as used herein, may refer to a direct connection and/or an indirect connection. For example, a direct coupling between two components may constitute and/or represent a coupling in which those two components are directly connected to each other by a single node that provides continuity from one of those two components to the other. In other words, the direct coupling may exclude and/or omit any additional components between those two components.

Additionally or alternatively, an indirect coupling between two components may constitute and/or represent a coupling in which those two components are indirectly connected to each other by multiple nodes that fail to provide continuity from one of those two components to the other. In other words, the indirect coupling may include and/or incorporate at least one additional component between those two components.

In some examples, one or more components and/or features illustrated in FIGS. 1-4 may be excluded and/or omitted from the various apparatuses, devices, and/or systems described in connection with FIGS. 1-4. Moreover, although these apparatuses, devices, and/or systems are often described above in terms of their configurations and/or capabilities, these apparatuses, devices, and/or systems may also actually perform any of the functionalities, behaviors, and/or services associated with those configurations and/or capabilities. For example, a radio device configured to transmit and receive RF signals may also actually transmit and receive RF signals. Conversely, although these apparatuses, devices, and/or systems are often described above in terms of their functionalities, behaviors, and/or services, these apparatuses, devices, and/or systems may also actually be configured to perform such functionalities, behaviors, and/or services.

FIG. 5 is a flow diagram of an exemplary method 500 for configuring, assembling, and/or programming apparatuses, devices, or systems capable of calibrating multi-port radio devices. In one example, the steps shown in FIG. 5 may be achieved and/or accomplished by radio and/or radar equipment manufacturer and/or subcontractor. Additionally or alternatively, the steps shown in FIG. 5 may incorporate and/or involve certain sub-steps and/or variations consistent with the descriptions provided above in connection with FIGS. 1-4.

As illustrated in FIG. 5, method 500 may include the step of communicatively coupling a plurality of ports included in a radio device to a poly-polarization antenna (510). Step 510 may be performed in a variety of ways, including any of those described above in connection with FIGS. 1-4. For example, a radio equipment manufacturer and/or subcontractor may communicatively couple a plurality of ports included in a radio device to a poly-polarization antenna. In this example, the plurality of ports may be characterized by one or more RF imbalances relative to one another.

Method 500 may also include the step of communicatively coupling circuitry to the radio device (520). Step 520 may be performed in a variety of ways, including any of those described above in connection with FIGS. 1-4. For example, the radio equipment manufacturer and/or subcontractor may communicatively couple circuitry to the radio device.

Method 500 may also include the step of configuring the circuitry to calibrate the radio device by compensating for the one or more RF imbalances based at least in part on a reference port included in the radio device (530). Step 530 may be performed in a variety of ways, including any of those described above in connection with FIGS. 1-4. For example, the radio equipment manufacturer and/or subcontractor may configure the circuitry to calibrate the radio device by compensating for the one or more RF imbalances based at least in part on a reference port included in the radio device.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference may be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A system comprising:
a radio device that comprises:
a plurality of ports characterized by one or more radio-frequency (RF) imbalances relative to one another; and
a reference port; and
circuitry configured to calibrate the radio device by compensating for the one or more RF imbalances based at least in part on the reference port.

2. The system of claim 1, wherein the radio device further comprises at least one of:
a transmitter that includes:
a plurality of transmitter ports characterized by the one or more RF imbalances; and
a reference transmitter port; and
a receiver that includes:
a plurality of receiver ports characterized by the one or more RF imbalances; and
a reference receiver port.

3. The system of claim 1, wherein the radio device further comprises at least one antenna configured to support communication in connection with the plurality of ports and the reference port.

4. The system of claim 3, wherein the radio device further comprises:
a first RF coupler that communicatively couples the at least one antenna, a first port included in the plurality of ports, and the reference port; and
a second RF coupler that communicatively couples the at least one antenna, a second port included in the plurality of ports, and the reference port.

5. The system of claim 4, wherein the radio device further comprises an RF divider that communicatively couples the reference port to the first RF coupler and the second RF coupler.

6. The system of claim 5, wherein:
the first RF coupler comprises a first input port communicatively coupled to the first port, a first coupled port communicatively coupled to the RF divider, and a first transmitted port communicatively coupled to the at least one antenna; and
the second RF coupler comprises a second input port communicatively coupled to the second port, a second coupled port communicatively coupled to the RF divider, and a second transmitted port communicatively coupled to the at least one antenna.

7. The system of claim 3, wherein the at least one antenna is tri-polarized to support communications of three different polarizations in connection with the plurality of ports and the reference port.

8. The system of claim 1, wherein the one or more RF imbalances comprises at least one of:
a differential between phases of the plurality of ports; or
a differential between gains of the plurality of ports.

9. The system of claim 1, wherein:
the plurality of ports comprises:
a first port that supports communications via a first RF signal of a first polarization; and
a second port that supports the communications via a second signal of a second polarization that differs from the first polarization; and
the reference port supports the communications via a third signal of a third polarization that differs from the first polarization and the second polarization.

10. The system of claim 9, wherein:
the first polarization and the second polarization are oriented orthogonal to one another; and
the third polarization is oriented at an offset between the first polarization and the second polarization.

11. The system of claim 9, wherein:
the first polarization comprises a horizontal polarization;
the second polarization comprises a vertical polarization; and
the third polarization comprises a positive or negative slant 45-degree polarization.

12. The system of claim 1, wherein the circuitry is further configured to:
generate a matrix representing a characterization of the radio device based at least in part on the reference port;
determine one or more calibration factors based at least in part on the matrix; and
calibrate the radio device to account for the one or more calibration factors.

13. The system of claim 12, wherein the matrix comprises:
one or more estimates of polarization states of the plurality of ports;
one or more estimates of the one or more RF imbalances; and
a target calibration response.

14. The system of claim 12, wherein the matrix implements at least one of:
Jones calculus; or
Mueller calculus.

15. The system of claim 12, wherein:
the one or more calibration factors comprise a target-response matrix representing an objective calibration of the radio device; and
the circuitry is further configured to calibrate the radio device based at least in part on the target-response matrix.

16. An apparatus comprising:
a radio device that comprises:
a poly-polarization antenna;
a horizontally polarized port and a vertically polarized port communicatively coupled to the poly-polarization antenna, the horizontally polarized port and the vertically polarized port being characterized by one or more radio-frequency (RF) imbalances relative to one another; and
a reference port; and
circuitry configured to calibrate the radio device by compensating for the one or more RF imbalances based at least in part on the reference port.

17. The apparatus of claim 16, wherein the radio device further comprises at least one of:
a transmitter that includes:
a plurality of transmitter ports characterized by the one or more RF imbalances; and
a reference transmitter port; and
a receiver that includes:
a plurality of receiver ports characterized by the one or more RF imbalances; and
a reference receiver port.

18. The apparatus of claim 16, wherein the radio device further comprises:
a first RF coupler that communicatively couples the poly-polarization antenna, the horizontally polarized port, and the reference port; and
a second RF coupler that communicatively couples the poly-polarization antenna, the vertically polarized port, and the reference port.

19. The apparatus of claim 18, wherein the radio device further comprises an RF divider that communicatively couples the reference port to the first RF coupler and the second RF coupler.

20. A method comprising:
communicatively coupling a plurality of ports included in a radio device to a poly-polarization antenna, the plurality of ports being characterized by one or more radio-frequency (RF) imbalances relative to one another;
communicatively coupling circuitry to the radio device; and
configuring the circuitry to calibrate the radio device by compensating for the one or more RF imbalances based at least in part on a reference port included in the radio device.
